(19) United States
(12) Patent Application Publication
(10) Pub. No.: US 2024/0053177 A1
(43) Pub. Date: Feb. 15, 2024

(54) DYNAMIC SAMPLING METHOD FOR ANALOG SENSOR AND DEVICES THEREOF

(71) Applicant: SHENZHEN GULI TECHNOLOGY CO., LTD., SHENZHEN (CN)

(72) Inventor: HONGYONG YU, SHENZHEN (CN)

(21) Appl. No.: 18/494,788

(22) Filed: Oct. 26, 2023

Related U.S. Application Data
(63) Continuation of application No. PCT/CN2021/092750, filed on May 10, 2021.

(30) Foreign Application Priority Data
Apr. 30, 2021 (CN) 202110485458.0

(51) Int. Cl. G01D 18/00

(52) U.S. Cl. CPC G01D 18/001; G01D 2205/90

(57) ABSTRACT

A dynamic sampling method for an analog sensor and devices thereof are disclosed. The method includes reading a predetermined sampling range, taking a minimum value of the predetermined sampling range as a minimum value of an actual sampling range, and taking a maximum value of the predetermined sampling range as a maximum value of the actual sampling range; sampling an output of the analog sensor to obtain an analog sampling value; outputting an actual sampling value according to a comparison result between the analog sampling value and the actual sampling range; and adjusting the actual sampling range according to the comparison result between the analog sampling value and the actual sampling range. The dynamic sampling method realizes a dynamic adjustment of the actual sampling range of the analog sensor. When the analog sampling value exceeds the predetermined sampling range, the actual sampling range is timely and dynamically updated.

### TECHNICAL FIELD

The present disclosure relates to a field of display technology, and in particular to a dynamic sampling method for an analog sensor and devices thereof.

### BACKGROUND

Currently, some analog sensors, such as Hall sensors, sliding rheostats, pressure sensors, capacitive position sensors, etc., commonly have errors in output values. On the one hand, there are individual differences in the analog sensors themselves, and on the other hand difference between external structures, such as housings or magnets where the analog sensors are installed, which jointly causes the errors in the output values.

In order to solve the problem, a conventional method is to set a relatively small and safe fixed value range to detect an output value of the analog quality sensor. Taking a sliding rheostat on a joystick of a game controller as an example, the sliding rheostat is installed on a shell of the game controller, and an actual output range of the sliding rheostat is normally 0.5V-2.7V. Taking into account the errors caused by individual difference in the sliding rheostat and the shell of the game controller, a sampling range of the sliding rheostat is limited to 0.7V-2.5V to prevent the joystick of the game controller from being unable to move to a maximum stroke to obtain a maximum actual output value. However, a limitation to the sampling range of the sliding rheostat affects user's control accuracy. Generally speaking, when the user moves the joystick, the actual output value of the sliding rheostat reaches a maximum actual output value, while the maximum stroke of the joystick is not reached, which brings a bad user experience to the user.

Therefore, when collecting analog sensor data, how to overcome the errors in the output values caused by the individual differences thereof and installation position differences of the analog sensor without affecting the actual output range of the analog sensors is an urgent technical problem to be solved.

### SUMMARY

The present disclosure provides a dynamic sampling method for an analog sensor and a computer device thereof to solve defects in the prior art.

In a first aspect, embodiments of the present disclosure provides the dynamic sampling method for the analog sensor. The dynamic sampling method for the analog sensor comprises
a step S1: reading a predetermined sampling range, taking a minimum value of the predetermined sampling range as a minimum value of an actual sampling range, and taking a maximum value of the predetermined sampling range as a maximum value of the actual sampling range;
a step S2: sampling an output of the analog sensor to obtain an analog sampling value;
a step S3: outputting an actual sampling value according to a comparison result between the analog sampling value and the actual sampling range;
a step S4: adjusting the actual sampling range according to the comparison result between the analog sampling value and the actual sampling range; and
a step S5: returning to execute the step S2.

Optionally, the step S3 comprises comparing the analog sampling value with the maximum value and the minimum value of the actual sampling range respectively. If the analog sampling value is within the actual sampling range, taking the analog sampling value as a sampling output value. If the analog sampling value is less than the minimum value of the actual sampling range, taking the minimum value of the actual sampling range as the sampling output value. If the analog sampling value is greater than the maximum value of the actual sampling range, taking the maximum value of the actual sampling range as the sampling output value.

Optionally, the step S4 comprises comparing the analog sampling value with the maximum value and the minimum value of the actual sampling range respectively. If the analog sampling value is within the actual sampling range, not adjusting the actual sampling range. If the analog sampling value is less than the minimum value of the actual sampling range, updating the minimum value of the actual sampling range with the analog sampling value. If the analog sampling value is greater than the maximum value of the actual sampling range, updating the maximum value of the actual sampling range with the analog sampling value.

Optionally, the step S3 further comprises determining an actual output value according to the sampling output value, the actual sampling range, and the actual output range.

Optionally, a difference between the maximum value of the actual sampling range minus the minimum value of the actual sampling range is defined as an actual sampling range amplitude. A difference between a maximum value of the actual output range minus a minimum value of the actual output range is defines as an actual output range amplitude. A ratio of the sampling output value to the actual sampling range amplitude is equal to a ratio of the actual output value to the actual output range amplitude.

Optionally, the analog sensor is configured to collect a joystick status signal of a remote controller.

Optionally, the analog sensor is a Hall sensor, a sliding rheostat, a pressure sensor, or a capacitive position sensor.

Optionally, the analog sampling value is a voltage value or a current value.

In a second aspect, the embodiments of the present disclosure provides a computer device. The computer device comprises a processor, a memory, and an analog sensor sampling device. The processor is configured to execute a computer program stored in the memory to implement the dynamic sampling method for the analog sensor mentioned above.

In a third aspect, the embodiments of the present disclosure provides a computer-readable storage medium. The computer-readable storage medium comprises a computer program stored in the computer-readable storage medium. When the computer program is executed by the processor, the dynamic sampling method for the analog sensor mentioned above is implemented.

In the dynamic sampling method for the analog sensor, by setting the predetermined sampling range, outputting the actual sampling value according to the comparison result between the analog sampling value and the actual sampling range, and adjusting the actual sampling range according to the comparison result between the analog sampling value and the actual sampling range after the actual sampling value is output, a dynamic adjustment of actual sampling range of the analog sensor is realized. Therefore, when the analog sampling value exceeds the predetermined sampling range, the actual sampling range is timely and dynamically updated to ensure that all values within the actual output range of the analog sensor are collected to adapt to applications in different occasions.

Especially in an application of joystick status signal collection for the remote controller, by setting the predetermined sampling range, parameter comparison, dynamic adjustment and using a current value, when the analog sampling value exceeds the predetermined sampling range, the actual sampling range is updated in real time. That is, a control range of the joystick of the remote controller controlled by the user is corrected without the user's awareness, avoiding voltage output errors caused by individual differences caused by mass production of different joysticks of different remote controllers, and ensuring remote control of the different remote controllers. Therefore, when each of the different joysticks of different remote controllers are controlled, each of the different joysticks is allowed to complete a whole stroke, which has high-precision and full-range use effects. Further, the present disclosure provides a relatively safe fixed predetermined sampling range value when replacing the remote controllers, which is conducive to choosing different remote controllers in a variety of ways.

### BRIEF DESCRIPTION OF DRAWINGS

FIG. 1 is a flow chart of a dynamic sampling method for an analog sensor according to a first embodiment of the present disclosure.

FIG. 2 is a flow chart of the dynamic sampling method for the analog sensor according to a second embodiment of the present disclosure.

### DETAILED DESCRIPTION

In order to explain technical solutions of the present disclosure clearly and completely, the present disclosure will be further described below in conjunction with the accompanying drawings.

### Embodiment 1

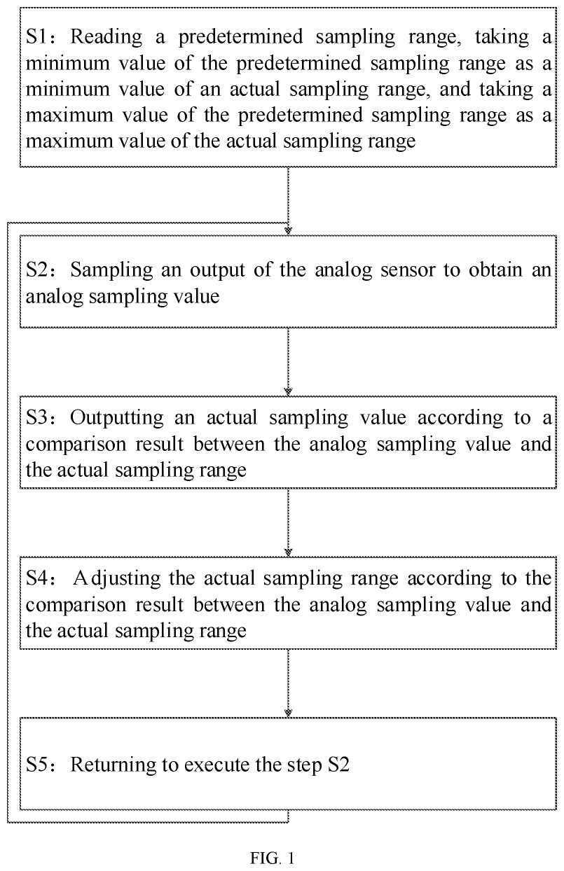

As shown in FIG. 1, in one embodiment, the present disclosure provides the dynamic sampling method for the analog sensor. The dynamic sampling method for the analog sensor comprises
a step S1: reading a predetermined sampling range, taking a minimum value of the predetermined sampling range as a minimum value of an actual sampling range, and taking a maximum value of the predetermined sampling range as a maximum value of the actual sampling range;
a step S2: sampling an output of the analog sensor to obtain an analog sampling value;
a step S3: outputting an actual sampling value according to a comparison result between the analog sampling value and the actual sampling range;
a step S4: adjusting the actual sampling range according to the comparison result between the analog sampling value and the actual sampling range; and
a step S5: returning to execute the step S2.

It should be noted that in the embodiment, the predetermined sampling range is stored in a non-volatile storage device. That is, data of the predetermined sampling range maintains even in an event of power failure. The predetermined sampling range is a relatively safe parameter range that is adapted to differences in an output range of the analog sensor caused by individual differences or differences in installation positions of different analog sensors installed on different housing structures. For example, a boundary of the predetermined sampling range may be within boundaries of output values of different analog sensors.

In the dynamic sampling method for the analog sensor, by setting the predetermined sampling range, outputting the actual sampling value according to the comparison result between the analog sampling value and the actual sampling range, and adjusting the actual sampling range according to the comparison result between the analog sampling value and the actual sampling range after the actual sampling value is output, a dynamic adjustment of actual sampling range of the analog sensor is realized. Therefore, when the analog sampling value exceeds the predetermined sampling range, the actual sampling range is timely and dynamically updated to ensure that all values within the actual output range of the analog sensor are collected to adapt to applications in different occasions.

In one optional embodiment, the step S3 comprises comparing the analog sampling value with the maximum value and the minimum value of the actual sampling range respectively. If the analog sampling value is within the actual sampling range, taking the analog sampling value as a sampling output value. If the analog sampling value is less than the minimum value of the actual sampling range, taking the minimum value of the actual sampling range as the sampling output value. If the analog sampling value is greater than the maximum value of the actual sampling range, taking the maximum value of the actual sampling range as the sampling output value.

In one optional embodiment, the step S4 comprises: comparing the analog sampling value with the maximum value and the minimum value of the actual sampling range respectively. If the analog sampling value is within the actual sampling range, not adjusting the actual sampling range. If the analog sampling value is less than the minimum value of the actual sampling range, updating the minimum value of the actual sampling range with the analog sampling value. If the analog sampling value is greater than the maximum value of the actual sampling range, updating the maximum value of the actual sampling range with the analog sampling value.

In one optional embodiment, the step S3 further comprises determining an actual output value according to the sampling output value, the actual sampling range, and the actual output range.

In one optional embodiment, a difference between the maximum value of the actual sampling range minus the minimum value of the actual sampling range is defined as an actual sampling range amplitude. A difference between a maximum value of the actual output range minus a minimum value of the actual output range is defines as an actual output range amplitude. A ratio of the sampling output value to the actual sampling range amplitude is equal to a ratio of the actual output value to the actual output range amplitude.

It should be noted that, in the embodiment of the present disclosure, the actual output value is data transmitted to a subsequent device or a subsequent program after the analog sensor collects data of a joystick and adjusts the data of the joystick. By performing the dynamic sampling method in the embodiment, it is ensured that any value in an output value range of the analog sensor is mapped to the actual output range.

In one optional embodiment, the analog sensor is configured to collect a joystick status signal of a remote controller. The remote controller is a game controller, an aircraft controller, or other remote controls involved in control operations.

In one optional embodiment, the analog sensor is a Hall sensor, a sliding rheostat, a pressure sensor, or a capacitive position sensor.

In one optional embodiment, the analog sampling value is a voltage value or a current value.

### Embodiment 2

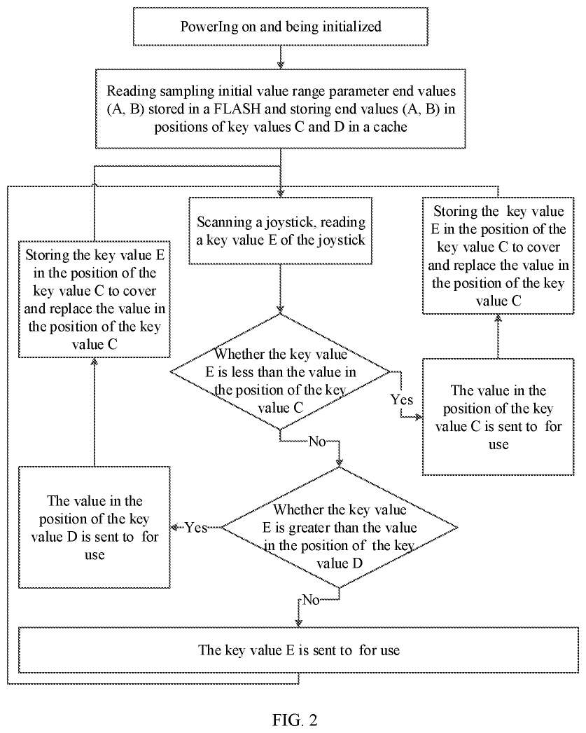

As shown in FIG. 2, the embodiment of the present disclosure provides the dynamic sampling method for the analog sensor applied in collecting joystick status of the remote control.

Specifically, when a data acquisition system or a data acquisition device is powered on and initialized, the data acquisition system or the data acquisition device reads sampling initial value range parameter end values (A, B) stored in a storage module (for example, a FLASH), and the sampling initial value range parameter end values are stored in a cache for use. At this time, the sampling initial value range parameter end value A is stored in a position of a key value C in the cache, and the sampling initial value range parameter end value B is stored in a position of a key value D in the cache. Then the joystick is scanned, and a key value E of the joystick is read.

In the embodiment, the key value E of the joystick is obtained by collecting the joystick status signal of the remote controller through the analog sensor. Thereafter, whether a value of the key value E of the joystick is less than a value in the position of the key value C (i.e., the end value A) in the cache is determined. If the value of the key value E of the joystick is less than the value in the position of the key value C in the cache, the value in the position of the key value C is sent to the remote controller for use, the value of the key value E is stored in the position of the key value C to cover and replace the value in the position of the key value C, and then returning to scan the joystick. If the value of the key value E of the joystick is not less than the value in the position of the key value C in the cache, whether the value of the key value E of the joystick is greater than a value in the position of the key value D (i.e., the end value B) in the cache is determined. If the value of the key value E of the joystick is greater than the value in the position of the key value D in the cache, the value in the position of the key value D is sent to the remote controller for use, the value of the key value E is stored in the cache to replaces the value in the position of the key value D, and then returning to scan the joystick. If the value of the key value E of the joystick is no more than the value in the position of the key value D in the cache, the he value of the key value E is sent to the remote controller for use. If power is turned off and then turned on again, the data acquisition system or the data acquisition device returns to an initial state.

Taking the joystick of the game controller adopting the sliding rheostat as an example, a sampling initial value range (i.e., the predetermined sampling range) of the sliding rheostat is 0.7-2.5 V. When in use, if a sampling voltage ranges from 0.5-3 V (i.e., the analog sampling value), the actual sampling range is dynamically adjusted to 0.5-3 V until the power is off After the sliding rheostat is powered on again, the sample initial value range is restored to 0.7-2.5 V. If the sampling voltage range of the sliding rheostat is 0.8-2.4 V, the sample initial value range of the sliding rheostat ranging from 0.7-2.5 V is served as the actual sampling range. If the sampling voltage range is 0.8-2.8 V in use, the actual sampling range is dynamically adjusted to 0.7-2.8 V, and if the sampling voltage range is 0.5-2.4 V in use, the actual sampling range is dynamically adjusted to 0.5-2.5 V.

By setting the predetermined sampling range, parameter comparison, dynamic adjustment and using a current value, when the analog sampling value exceeds the predetermined sampling range, the actual sampling range is updated in real time. That is, a control range of the joystick of the remote controller controlled by the user is corrected without the user's awareness, avoiding voltage output errors caused by individual differences caused by mass production of different joysticks of different remote controllers, and ensuring remote control of the different remote controllers. Therefore, when each of the different joysticks of different remote controllers are controlled, each of the different joysticks is allowed to complete a whole stroke, which has high-precision and full-range use effects. Further, the present disclosure provides a relatively safe fixed predetermined sampling range value when replacing the remote controllers, which is conducive to choosing different remote controllers in a variety of ways.

In addition, embodiments of the present disclosure further provides a computer device. The computer device comprises a processor, a memory, and an analog sensor sampling device. The processor is configured to execute a computer program stored in the memory to implement the dynamic sampling method for the analog sensor mentioned above.

The computer device may be a personal computer, an industrial personal computer, a microcontroller, a microprocessor, etc. The analog sensor sampling device may be an A/D converter, a modular analog acquisition unit or a data acquisition card, etc.

It is understood by those skilled in the art that all or parts of processes in the dynamic sampling method mentioned in the foregoing embodiments is able to be completed by controlling related hardware by a computer program, the computer program may be stored in a computer-readable storage medium. When executing the dynamic sampling method, the computer program executes the steps mentioned in embodiments of the dynamic sampling method. The computer-readable storage medium may be a magnetic disk, an optical disk, a read-only memory (ROM), a random access memory (RAM), a hard disk, a USB flash disk, a FLASH, etc.

Of course, the present disclosure also has various embodiments. Based on embodiments, other implementations can be obtained by those of ordinary skill in the art without any creative work, which should fall within the protection scope of the present disclosure.

What is claimed is:

1. A dynamic sampling method for an analog sensor, comprising:
a step S1: reading a predetermined sampling range, taking a minimum value of the predetermined sampling range as a minimum value of an actual sampling range, and taking a maximum value of the predetermined sampling range as a maximum value of the actual sampling range;
a step S2: sampling an output of the analog sensor to obtain an analog sampling value;
a step S3: outputting an actual sampling value according to a comparison result between the analog sampling value and the actual sampling range;
a step S4: adjusting the actual sampling range according to the comparison result between the analog sampling value and the actual sampling range; and
a step S5: returning to execute the step S2.

2. The dynamic sampling method for the analog sensor according to claim 1, wherein the step S3 comprises comparing the analog sampling value with the maximum value and the minimum value of the actual sampling range respectively; if the analog sampling value is within the actual sampling range, taking the analog sampling value as a sampling output value; if the analog sampling value is less than the minimum value of the actual sampling range, taking the minimum value of the actual sampling range as the sampling output value; and if the analog sampling value is greater than the maximum value of the actual sampling range, taking the maximum value of the actual sampling range as the sampling output value.

3. The dynamic sampling method for the analog sensor according to claim 2, wherein the step S4 comprises comparing the analog sampling value with the maximum value and the minimum value of the actual sampling range respectively; if the analog sampling value is within the actual sampling range, not adjusting the actual sampling range; if the analog sampling value is less than the minimum value of the actual sampling range, updating the minimum value of the actual sampling range with the analog sampling value; and if the analog sampling value is greater than the maximum value of the actual sampling range, updating the maximum value of the actual sampling range with the analog sampling value.

4. The dynamic sampling method for the analog sensor according to claim 2, wherein the step S3 further comprises determining an actual output value according to the sampling output value, the actual sampling range, and the actual output range.

5. The dynamic sampling method for the analog sensor according to claim 4, wherein a difference between the maximum value of the actual sampling range minus the minimum value of the actual sampling range is defined as an actual sampling range amplitude; a difference between a maximum value of the actual output range minus a minimum value of the actual output range is defines as an actual output range amplitude; a ratio of the sampling output value to the actual sampling range amplitude is equal to a ratio of the actual output value to the actual output range amplitude.

6. The dynamic sampling method for the analog sensor according to claim 1, wherein the analog sensor is configured to collect a joystick status signal of a remote controller.

7. The dynamic sampling method for the analog sensor according to claim 1, wherein the analog sensor is a Hall sensor, a sliding rheostat, a pressure sensor, or a capacitive position sensor.

8. The dynamic sampling method for the analog sensor according to claim 1, wherein the analog sampling value is a voltage value or a current value.

9. A computer device, comprising:
a processor,
a memory, and
an analog sensor sampling device;
wherein the processor is configured to execute a computer program stored in the memory to implement the dynamic sampling method for the analog sensor according to claim 1.

10. A computer-readable storage medium, comprising: a computer program stored in the computer-readable storage medium;
wherein when the computer program is executed by a processor, the dynamic sampling method for the analog sensor according to claim 1 is implemented.
